(19) United States
(12) Patent Application Publication
(10) Pub. No.: US 2009/0094682 A1
(43) Pub. Date: Apr. 9, 2009

(54) METHODS AND SYSTEMS FOR USER AUTHORIZATION

(76) Inventors: Peter Sage, Stephentown, NY (US); Chandran Elumalal, Mansfield, MA (US); Robert Gendron, Salem, MA (US)

Correspondence Address: General Electric Company;GE Global Patent Operation, PO Box 861, 2 Corporate Drive, Suite 648, Shelton, CT, 06484, US

(21) Appl. No.: 11/867,750

(22) Filed: Oct. 5, 2007

(51) Int. Cl. H04L 9/32

(52) U.S. Cl. 726/4; 726/16; 726/17

(57) ABSTRACT

A method for controlling access to a system is provided. The method includes creating a role tree including a plurality of privileges, creating a resource tree including a plurality of resources, assigning at least one role for at least one resource to a user, and evaluating the plurality of privileges of the user for a requested service access based on at least one of a user role assignment, a user resource assignment, and a location of a device used by the user to request the service access.

### BACKGROUND OF THE INVENTION

The methods and systems described herein relate generally to automation and/or manufacturing systems and, more particularly, to simplifying system configuration for user authentication and authorization.

At least some known distributed automation and/or manufacturing systems include a large number of resources requiring differing levels of access and control. A system administrator may spend considerable time configuring and maintaining the authorization system configuration, making the administrator unavailable for other system-related tasks. Alternatively, the administrator may simply disable the authorization system entirely or grant wide-ranging rights to a broad set of users, thereby making the system less secure.

At least some known authorization systems use the concept of users and roles, wherein each user is assigned a role that includes a certain level of access and control privileges. Configuration of such a system may quickly become cumbersome without a mechanism to establish different roles for different system resources. One approach to reducing this problem is to define a large number of specific roles and set the operation privileges accordingly. However, the number of roles required expands linearly with the addition of new resources.

### BRIEF DESCRIPTION OF THE INVENTION

In one aspect, a method for controlling access to a system is provided. The method includes creating a role tree including a plurality of privileges, creating a resource tree including a plurality of resources, assigning at least one role for at least one resource to a user, and evaluating the plurality of privileges of the user for a requested service access based on at least one of a user role assignment, a user resource assignment, and a location of a device used by the user to request the service access.

In another aspect, a method for authorizing user access to a system is provided. The method includes assigning the user to at least one role for at least one resource, the at least one role chosen from a role tree and the at least one resource chosen from a resource tree, determining a user's role assignment, a user's resource assignment, and a user location, and evaluating the user's role assignment, the user's resource assignment, and the user location against at least one of a required role and a required privilege for a requested service for a requested resource.

In a further aspect, a role and resource based authorization and authentication system includes at least one user device and at least one server communicatively coupled to the at least one user device. The at least one server includes a role tree and a resource tree, and is configured to store a set of privileges for a user, the set of privileges based on a user assignment to at least one role for at least one resource, compare the set of privileges for the user and a user location to a set of required privileges and a location required to access a requested service for a requested resource, and one of grant and deny access to the requested service for the requested resource based on the comparison.

### BRIEF DESCRIPTION OF THE DRAWINGS

FIGS. 1-5 show exemplary embodiments of the systems and methods described herein. The systems and methods shown in FIGS. 1-5 and described in conjunction with FIGS. 1-5 are exemplary only.

FIG. 1 is a schematic diagram of an exemplary authorization system;

FIG. 2 is a diagram of an exemplary role tree that may be used with the authorization system shown in FIG. 1;

FIG. 3 is a diagram of an exemplary resource tree that may be used with the authorization system shown in FIG. 1;

FIG. 4 is a diagram illustrating the relationship between roles and resources in the authorization system shown in FIG. 1; and

FIG. 5 is a flow chart illustrating an exemplary method for controlling access using the authorization system shown in FIG. 1.

### DETAILED DESCRIPTION OF THE INVENTION

The technical effect of the described embodiments is to provide systems and methods for controlling access to an automated system configured to perform base services. In the exemplary embodiment, the system includes a directory of resources. The resources include machines included in the automated system and programming services that are used to support the machines. The system links the resources based on common programmability and integrates the resources to perform base services of the automated system.

As used herein, the term “role” describes a permission to perform any one of a defined set of operations on a defined set of objects. Roles can be assumed by a set of people, e.g., a group, to allow them to operate on a set of objects, e.g., a resource. Generally, objects can be classified in more than one way and people can assume more than one role and be a member of more than one group.

As used herein, the term “authorization specification” is a three-dimensional matrix of people, objects, and operations. If the value of {x,y,z} is true, then person x can apply operation z to object y. Similarly, as used herein, the term “authorization matrix,” which may be expressed as {X,Y,Z}, includes a set of groups, X, a set of resource classifications, Y, and a set of roles, Z. In a typical organization, X<<x, Y<<y, and Z<<z.

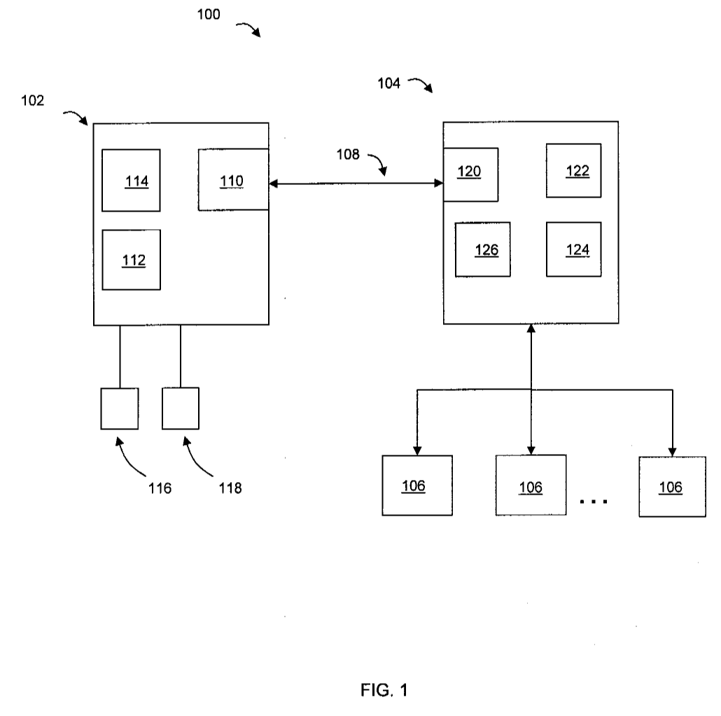

FIG. 1 is a schematic diagram of an exemplary authorization system 100. The system can be implemented on many different platforms and utilize many different architectures. The architectures shown in FIG. 1 are exemplary only. In the exemplary embodiment, system 100 includes at least one client 102, at least one server 104, and at least one resource 106. System 100 is interconnected by a network 108. In one embodiment, network 108 is a wide area network (WAN), such as the Internet. In an alternative embodiment, network 108 is a local area network (LAN), such as an intranet. Network 108 includes the physical medium and intermediate devices (not shown), such as routers and switches, that connect the elements of system 100 described above.

Client 102 is communicatively connected to network 108 via a network interface 1 10. A user accesses, such as dialing into, or directly logging into, an intranet or the Internet to gain access to system 100. Client 102 may connect to network 108 through many interfaces including a different network (not shown), such as a WAN or a LAN, dial in connections, cable modems, wireless networks, and special high-speed ISDN lines. Client 102 is any device capable of interconnecting to network 108, including a web-based telephone or other web-based connectable equipment. Client 102 may be a stand-alone client, such as a thin client, that runs only an operating system and an application for accessing and communicating with system 100. Alternatively, client 102 may operate as an application that is installed on a personal computer (PC) and may run similarly and/or concurrently with other programs. Client 102 also includes a system memory 112 electrically connected to a system bus (not shown) and, in one embodiment, includes an operating system and a user-oriented program and data. In the exemplary embodiment, client 102 also includes user interaction devices such as a display 114, a keyboard 116, and/or a mouse 118.

Server 104 is also communicatively coupled to network 108 via a network interface 120. Server 104 includes a system memory 122 electrically connected to a system bus (not shown) and, in one embodiment, includes an operating system. In the exemplary embodiment, memory 122 includes a database 124, which includes an authorization matrix and a directory of resources. More specifically, database 124 includes all people, objects, and operations for system 100. In the exemplary embodiment, server 104 also includes at least one processor 126. Moreover, in the exemplary embodiment, server 104 is a Lightweight Directory Access Protocol (LDAP) server.

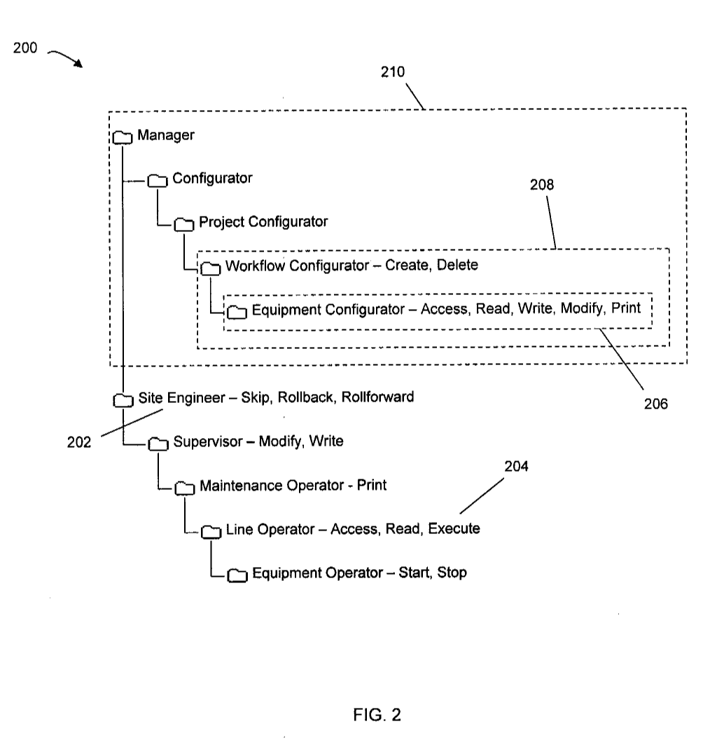

FIG. 2 is a diagram of an exemplary role tree 200 that may be used with system 100 (shown in FIG. 1). In the exemplary embodiment, each user or group of users of system 100 is assigned to one or more roles 202. Alternatively, a user may be assigned to a role 202 by virtue of belonging to a group and may be assigned to a different role 202 separately from the rest of the users of the same group. In one embodiment, user groups are organized using Microsoft Windows domain groups. Alternatively, any suitable user and group mapping methodology may be used that enables system 100 to function as described herein.

Each role 202 includes a set of designated privileges 204. In one embodiment, role 202 is formed by grouping one or more privileges 204. For example, an Equipment Configurator role 206 includes privileges such as Access, Read, Write, Modify, and Print. In an alternative embodiment, role 202 includes a group of roles 202 and privileges 204. For example, a Workflow Configurator role 208 includes all privileges assigned to its child role and additional privileges. As shown in FIG. 2, therefore, Workflow Configurator role 208 includes all privileges assigned to Equipment Configurator role 206 (Access, Read, Write, Modify, and Print) but also additional privileges not granted to Equipment Configurator role 206 (Create and Delete). In an alternative embodiment, role 202 includes a group of multiple roles and associated privileges 204. For example, a Manager role 210 includes all privileges assigned to all of the children roles. As shown in FIG. 2, therefore, Manager role 210 includes all privileges assigned to a Configurator role, a Project Configurator role, Workflow Configurator role 208, and Equipment Configurator role 206.

In the exemplary embodiment, a user may be assigned a single privilege 204 that the remaining members of the user's group and/or role are not assigned. Moreover, a user may be restricted from a single privilege 204 even though the remaining members of the user's group and/or role were not restricted.

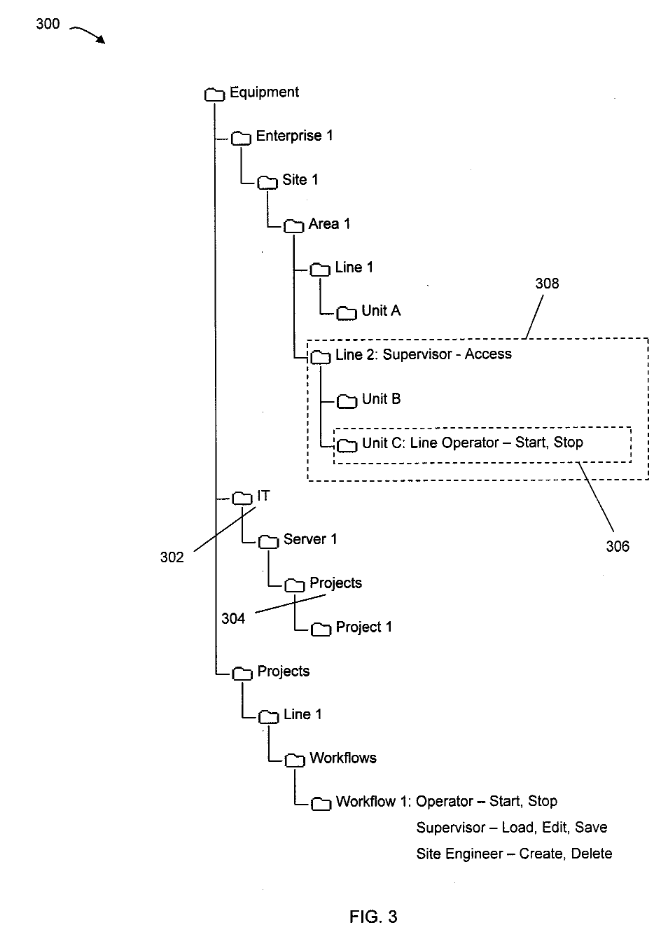

FIG. 3 is a diagram of an exemplary resource tree 300 that may be used with system 100 (shown in FIG. 1). In the exemplary embodiment, resource tree 300 includes a plurality of resource types 302 and a plurality of resource nodes 304. Individual resource nodes 304 may include different authorization requirements. More specifically, resource node 304 may require a particular user role 202 (shown in FIG. 2) and/or a particular privilege 204 (shown in FIG. 2) in order to access resource node 304. For example, a Unit C resource node 306 requires a user to be assigned a Line Operator role in order to access the Start and Stop operations for Unit C resource node 306. In the exemplary embodiment, resource tree 300 is organized in an hierarchical fashion. For example, a user with a Supervisor role and with an Access privilege will have the Access privilege on any resource node that is a child of a Line 2 resource node 308. Therefore, a user with a Supervisor role on Site 1 will have the Access privilege on, for example, Unit C resource node 306. Further, because a user with a Supervisor role will also have all privileges assigned to the Line Operator role, the Supervisor role user will have the Start and Stop privileges on Unit C resource node 306.

In the exemplary embodiment, an authorization context is expressed as a list of requirements for the operations of resource node 304. For example, an authorization context of the Projects-Line 1-Workflows-Workflow 1 hierarchy is expressed below.

| Role | Privilege |
|---|---|
| Operator | Start, Stop |
| Supervisor | Load, Edit, Save |
| Site Engineer | Create, Delete |

In the above authorization context, a user assigned the Operator role for Line 1 will be denied access to the Load operation for the Workflow 1 resource node. However, a user assigned the Supervisor role for Line 1 can access the Start and Stop operations for the Workflow 1 resource node as long as the Supervisor role derives the specific rights from the Operator role by virtue of the relationship of the two roles in role tree 200 (shown in FIG. 2). The authorization context of a particular operation for a particular resource is the collection of all requirements to access the resource and the operation. In one embodiment, the authorization context of a resource is configured using a Microsoft Windows Security Plug-In applet. Alternatively, any suitable component for configuring the access requirements for a resource and/or an operation may be used.

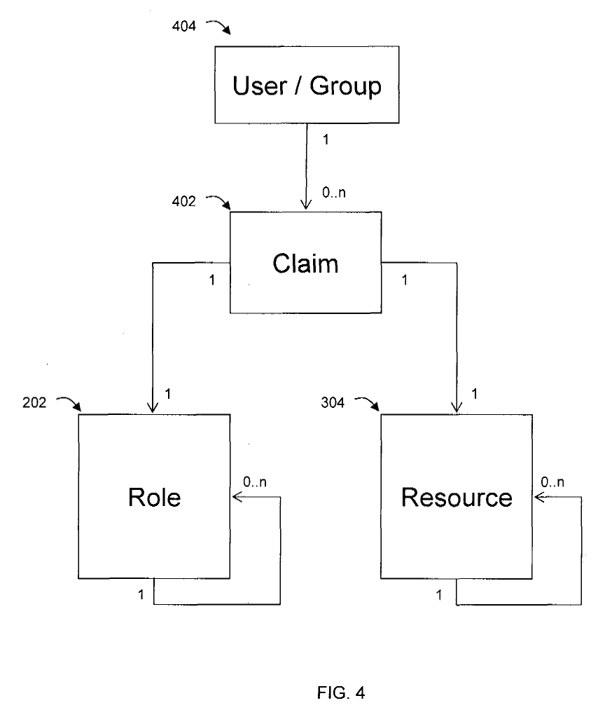

FIG. 4 is a diagram illustrating the relationship between roles and resources in system 100 (shown in FIG. 1). In the exemplary embodiment, role tree 200 (shown in FIG. 2) and resource tree 300 (shown in FIG. 3) are related through the use of ResourceRole claims and ResourceOperation claims, such as claim 402. Each role 202 is explicitly associated on each resource node 304 of resource tree 300. Moreover, each role 202 includes one or more privileges 204 (shown in FIG. 2) and/or one or more roles 202. Further, each resource 304 may include one or more resources 304. In the exemplary embodiment, each claim 402 includes one role 202 and one resource 304 and each user 404 is assigned one or more claims 402. For example, ResourceRole claims are associated with users and/or groups of users. As another example, ResourceOperation claims are used to grant operational level for a particular user and/or a group of users for a particular resource node 304. Whether claims 402 are of the ResourceRole type or the ResourceOperation type, claims 402 associated with all roles 202 assigned to user 404 form the evaluation claim set of user 404 for accessing the resources. An example of a ResourceRole claim set is expressed below.

| Type | Right | Value/Resource |
|---|---|---|
| ResourceRole | Line Operator | LDAP Address of Line 2 |
| ResourceRole | Supervisor | LDAP Address of Workflow root |

Referring to FIGS. 2 and 3, if the above user is assigned to a Line Operator role for the Line 2 resource and is assigned to a Supervisor role for the Workflows resource, the user will be able to access any operation on the respective resource trees for which the Line Operator role and the Supervisor role are privileged. For example, the user will be able to access the Edit operation for the Workflows resource because the Supervisor role has been assigned a privilege for the Edit operation on the Workflows resource and, hence, all children of the Workflows resource. However, if the user attempts to access the Create operation for the Workflows resource, the access is denied because the user has not been assigned that privilege independently nor by virtue of being assigned to the Site Engineer role.

In the exemplary embodiment, access to an operation for which a user is not currently privileged may be provided outside of assigning the user to a new role. For example, access to the Create operation for the Workflows resource may be granted to the hypothetical user above, as expressed below.

| Type | Right | Value/Resource |
|---|---|---|
| ResourceOperation | Create | LDAP Address of Workflow root |

Additionally, access to an operation for which a user is currently privileged may be restricted outside of revoking the user's assignment to a role. For example, access to the Stop operation, for which the above user is currently privileged by virtue of the Line Operator role assignment, may be restricted as expressed below.

| Type | Right | Value/Resource |
|---|---|---|
| ResourceOperation | -Stop | LDAP Address of Workflow root |

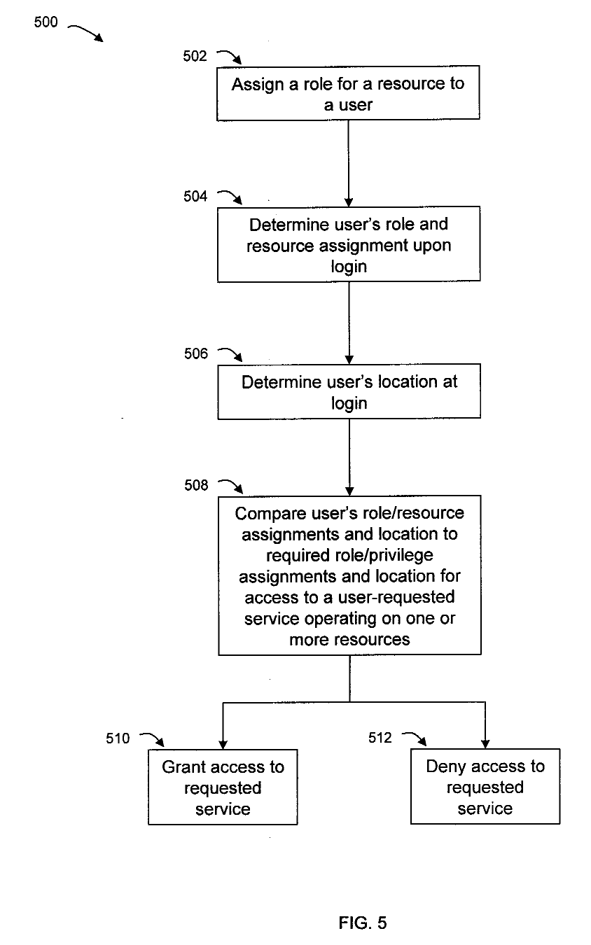

FIG. 5 is a flow chart illustrating an exemplary method 500 for controlling access to a system, such as system 100 (shown in FIG. 1). In the exemplary embodiment, each user is assigned 502 to at least one role 202 (shown in FIG. 2) for at least one resource node 304 (shown in FIG. 3) corresponding to resource 106 (shown in FIG. 1). As described above, assigning 502 a user to a role 202 for a resource node establishes a claim set for the user. Each claim set includes at least one claim type, at least one right, and at least one resource. Each claim type may be a ResourceRole claim, wherein the user is assigned privileges for the assigned role and for any roles beneath the assigned role in the hierarchy established by role tree 200. Alternatively, each claim may be an ResourceOperation claim, wherein the user is assigned at least one specific privilege for a specific operation on a specific resource node.

In the exemplary embodiment, a user logs into system 100 from a client 102 (shown in FIG. 1). During login and for the remainder of the user's session, all network traffic is funneled through an application server 104 (shown in FIG. 1). More specifically, a login service for user authentication runs as a service on server 104. During login, all claims for the user are determined 504 by server 104. In the exemplary embodiment, a query is submitted to database 124 (shown in FIG. 1) for all claims, including roles 202 and resource nodes 304, wherein the claims are made available for authorization. In one embodiment, a session key is generated using, for example, a random number, a time stamp, the user name, and/or an IP address. The session key is encrypted with a user-specific key using a hashing algorithm. The encrypted session key is then transmitted to client 102. Client 102 decrypts the key and adds a predetermined fixed value. The result is used to make secure calls to server 104 for the remainder of the session. Upon receiving a call from client 102, server 104 extracts the key to ensure the user's identity and the session's identity. Transmitting only the secure key and a service call, rather than repetitively transmitting the user claim set, facilitates reducing the amount of network traffic between client 102 and server 104. Additionally, loading the user's claim set and referring to the claim set thereafter facilitates reducing the latency for authorization checks between client 102 and server 104 by eliminating the need to repetitively make queries to database 124 regarding the user's assigned privileges.

In the exemplary embodiment, the user's location is then determined 506. The user's location, along with the user's role 202 and resource node 304 assignments, determine whether the user will be granted access to a requested operation for resource 106. If the user attempts to access an operation outside of a predetermined location, the requested access to an operation will be denied. In one embodiment, the physical computer name of client 102 from which the user accesses server 104 acts as the user location. In an alternative embodiment, client 102 includes a GPS module and transmits the GPS coordinates to server 104 during the authorization check. In a further alternative embodiment, client 102 transmits the GPS coordinates of the user to server 104. In this embodiment, the user may enter the coordinates into client 102 or may connect a wearable GPS module to client 102 such that client 102 reads the coordinates and transmits the coordinates to server 104. Further alternative embodiments may include different positioning coordinate communication systems.

In the exemplary embodiment, when the user requests access to an operation for resource 106 an authorization check is made. Server 104 compares 508 the user's role 202 assignment, resource node 304 assignment, and location to those specified for a corresponding resource node 304 in resource tree 300. If each comparison is positive, the user is granted 510 access to the requested operation. If one comparison is negative, the user is denied 512 access to the requested operation.

In one embodiment, method 500 is completed on resource 106 in addition to server 104. In this embodiment, an authorization check is injected into a call from client 102 to resource 106 for access to an operation. Server 104 constructs the call, or proxy, such that when client 102 calls for access to an operation, the authorization check runs first to ensure that the user meets the requirements for accessing the operation. More specifically, server 104 constructs the proxy and transmits the proxy to client 102. The proxy includes both an authorization method execution path and an operation method execution path. The authorization method is executed by server 104 prior to the operation method. When the user requests access to an operation for a particular resource 106, the authorization method is executed as described above. If the user's role 202 assignment, resource node 304 assignment, and location match the requirements of the requested operation for resource 106, access is granted 510 and the operation method is executed. Use of a proxy facilitates normalizing the authorization methods and behaviors of each resource 106. In an alternative embodiment, client 102 is configured to check a user authorization according to method 500, and in addition to an authorization check completed by server 104. In this embodiment, client 102 compares the user's role 202 assignment, resource node 304 assignment, and location against the requirements of one or more operations displayed in a client user interface. The results of the comparison allow client 102 to update the client user interface with respect to the operations the user is privileged to access and the operations the user is not privileged to access. For example, the client user interface makes unavailable operations inaccessible to the user by, for example, blocking user-selectable elements such as check boxes and/or radio buttons. Alternatively, the client user interface colors each unavailable operation in a contrasting color to available operations. In this embodiment, a user-requested service access is subjected to an authorization check by server 104 prior to execution.

In summary, in one embodiment, a method for controlling access to a system includes creating a role tree including a plurality of privileges, creating a resource tree including a plurality of resources, assigning at least one role for at least one resource to a user, and evaluating the privileges of the user for a requested service access based on at least one of a user role assignment, a user resource assignment, and a location of a device used by the user to request the service access.

In one embodiment, creating a role tree includes storing a hierarchy of privileges and forming a role including at least one privilege. In an alternative embodiment, forming a role includes grouping at least one of other roles stored in the role tree and a combination of roles and privileges.

Moreover, in one embodiment, creating a resource tree includes storing a hierarchy of the plurality of resources and a plurality of resource types and assigning a resource operation to one of a role and a privilege relating to the operation.

Further, in one embodiment, the method also includes determining the location of the device used by the user based on at least one of a name of the device and a set of positioning coordinates.

Additionally, in one embodiment, evaluating the privileges of the user for a requested service access includes loading the plurality of privileges of the user into a server memory, transmitting a secure key and a request to access a service to a server, and comparing at least one of a user role assignment and a user resource assignment against at least one of a required role and a required privilege for the requested service for the requested resource.

Moreover, in one embodiment, the method also includes injecting an authorization method execution path into a method execution path of the requested service access.

The above-described embodiments of methods and systems for controlling access to an automated system facilitate ensuring that only users with appropriate privileges are able to request service access for a particular resource. For example, security measures built in a system ensure that the system is secure and meets real-time and operational constraints. The ability for a system administrator to assign a user to a role for a particular resource facilitates simplifying system configuration. Moreover, integrating user device location requirements facilitates securing the system by requiring a user to be at a specific location in order to access an operation for a resource.

Although the above-described embodiments are described with respect to automated systems, as will be appreciated by one of ordinary skill in the art, the present invention may also apply to any suitable system and/or manufacturing process. Further, although the present invention is described with respect to a directory of resources, as will be appreciated by one of ordinary skill in the art, the present invention may also apply to any accumulation of resources that operates as described herein.

While the invention has been described in terms of various specific embodiments, those skilled in the art will recognize that the invention can be practiced with modification within the spirit and scope of the claims.

What is claimed is:

1. A method for controlling access to a system, said method comprising:
creating a role tree including a plurality of privileges;
creating a resource tree including a plurality of resources;
assigning at least one role for at least one resource to a user; and
evaluating the plurality of privileges of the user for a requested service access based on at least one of a user role assignment, a user resource assignment, and a location of a device used by the user to request the service access.

2. A method in accordance with claim 1 wherein creating a role tree further comprises:
storing a hierarchy of privileges; and
forming a role including at least one privilege.

3. A method in accordance with claim 2 wherein forming a role further comprises grouping at least one of other roles stored in the role tree and a combination of roles and privileges.

4. A method in accordance with claim 1 wherein creating a resource tree further comprises:
storing a hierarchy of the plurality of resources and a plurality of resource types; and
assigning a resource operation to one of a role and a privilege relating to the operation.

5. A method in accordance with claim 1 further comprising determining the location of the device used by the user based on at least one of a name of the device used by the user and a set of positioning coordinates.

6. A method in accordance with claim 1 wherein evaluating the plurality of privileges of the user for a requested service access further comprises:
loading the plurality of privileges of the user into a server memory;
transmitting a secure key and a request to access a service to a server; and
comparing at least one of a user role assignment and a user resource assignment against at least one of a required role and a required privilege for the requested service for the requested resource.

7. A method in accordance with claim 1 further comprising injecting an authorization method execution path into a method execution path of the requested service access.

8. A method for authorizing user access to a system, said method comprising:
assigning the user to at least one role for at least one resource, the at least one role chosen from a role tree and the at least one resource chosen from a resource tree;
determining a user's role assignment, a user's resource assignment, and a user location; and
evaluating the user's role assignment, the user's resource assignment, and the user location against at least one of a required role and a required privilege for a requested service for a requested resource.

9. A method in accordance with claim 8 wherein assigning the user to at least one role for at least one resource further comprises:
storing a plurality of privileges; and
creating a role tree by grouping at least one privilege to form a role.

10. A method in accordance with claim 9 wherein creating a role tree further comprises creating a role tree by grouping at least one of other roles stored in the role tree and a combination of roles and privileges.

11. A method in accordance with claim 8 wherein assigning the user to at least one role for at least one resource further comprises:
storing a plurality of resources and resource types; and
creating a resource tree.

12. A method in accordance with claim 8 wherein determining a user's role assignment, a user's resource assignment, and a user location further comprises at least one of reading a physical name of a device used by the user and reading a set of positioning coordinates of the device used by the user.

13. A method in accordance with claim 8 further comprising injecting an authorization method execution path into a method execution path of the requested service.

14. A role and resource based authorization and authentication system comprising:
at least one user device; and
at least one server communicatively coupled to said at least one user device, said at least one server comprising a role tree and a resource tree, said at least one server configured to:
store a set of privileges for a user, the set of privileges based on a user assignment to at least one role for at least one resource;
compare the set of privileges for the user and a user location to a set of required privileges and a location required to access a requested service for a requested resource; and
one of grant and deny access to the requested service for the requested resource based on the comparison.

15. A role and resource based authorization and authentication system in accordance with claim 14 wherein said at least one user device further comprises a physical name, said at least one user device configured to communicate the physical name to said at least one server.

16. A role and resource based authorization and authentication system in accordance with claim 14 wherein said at least one user device further comprises a GPS module, said at least one user device configured to communicate a set of GPS coordinates to said at least one server.

17. A role and resource based authorization and authentication system in accordance with claim 14 wherein said role tree further comprises a plurality of privileges and a plurality of roles, each role of said plurality of roles formed by at least one of a set of privileges of said plurality of privileges and at least one other role of said plurality of roles.

18. A role and resource based authorization and authentication system in accordance with claim 14 wherein said resource tree further comprises a plurality of resources and a plurality of resource types.

19. A role and resource based authorization and authentication system in accordance with claim 14 wherein said at least one server is further configured to inject an authorization method execution path into a method execution path for the requested service.

20. A role and resource based authorization and authentication system in accordance with claim 14 wherein said at least one user device and said at least one server are configured to securely communicate using a token exchange protocol, and wherein the set of privileges for the user is loaded into a server memory to facilitate reducing network traffic between said at least one user device and said at least one server.
